(19) United States
(12) Patent Application Publication
(10) Pub. No.: US 2021/0033235 A1
(43) Pub. Date: Feb. 4, 2021

(54) UNIVERSAL FEMALE CONNECTOR

(71) Applicant: HUI BAO ENTERPRISE CO., LTD., CHANGHUA COUNTY (TW)

(72) Inventor: WAN PAO CHEN, CHANGHUA COUNTY (TW)

(21) Appl. No.: 16/556,803

(22) Filed: Aug. 30, 2019

(30) Foreign Application Priority Data
Aug. 2, 2019 (TW) 108210243

(51) Int. Cl. F16L 37/40; F16L 37/12

(52) U.S. Cl. CPC F16L 37/40; F16L 37/12

(57) ABSTRACT

A universal female connector includes a body having a first path and a second path which communicates with the first path. A movable unit is movably located within the first path and includes an elongate hollow part with a first seal received therein. Multiple heads are movably attached to the elongate hollow part. A valve unit is located in the second path of the body. A button unit is movably inserted into a hole transversely defined through the body to position the elongate hollow part in the body. When a male connector is connected to the elongate hollow part and pushes the first seal, the elongate hollow part with the beads are moved and positioned by the button unit to communicate the first and second paths. When the button unit is pushed, the movable unit moves to its initial position, and the male connector is removed from the movable body.

### BACKGROUND OF THE INVENTION

### 1. Field of the Invention

The present invention relates to a universal female connector, and more particularly, to a universal female connector that is able to be connected with different types of male connectors.

### 2. Descriptions of Related Art

There are many types of connectors used in the industrial field about fluid, and generally include a female connector and a male connector which is connected to the female connector so as to connect two pipes through which fluid goes.

As shown in FIG. 10 which discloses existed male connectors 9, such as the Industrial male connector 91, the Aro male connector 92, the Truflate male connector 93, the Rectus male connector 94 and the Italian male connector 95. Each male connector 9 in FIG. 10 includes a groove 901. It is noted that each specific male connector 9 requires a compatible female connector so as to successfully connect two pipes. Nevertheless, different work sites may not have the required female connectors available, therefore, the users have to find suitable male connectors, and this wastes a lot of time.

The present invention intends to provide a universal female connector which is easily connected to different types of male connectors. Besides, the universal female connector of the present invention is safe and reliable.

### SUMMARY OF THE INVENTION

The present invention relates to a universal female connector and comprises a body having a head part and a tail part respectively connected to two ends of the body. A first path is defined axially through the head part and the body, and a second path is defined axially through the tail part. The first path communicates with the second path. The head part includes an annular recess defined in the inner periphery thereof. A hole is defined transversely through the wall of the body and communicates with the first path.

A movable unit is movably located within the first path, and includes an elongate hollow part which has a first end and a second end. The diameter of the first end of the elongate hollow part is larger than that of the second end of the elongate hollow part. A first seal is located in the elongate hollow part. Multiple beads are movably located in apertures defined through the wall of the first end of the elongate hollow part. Multiple engaging portions are formed on the outside of the middle portion of the elongate hollow part.

A valve unit is located in the second path of the tail part and includes a second seal, so as to prevent air in the second path from entering into the first part. A button unit is movably inserted into the hole of the body to position the elongate hollow part.

Preferably, the first seal is pushed by a male connector that is connected to the head part, when the male connector pushes the first seal, the elongate hollow part is pushed to be engaged with the button unit, and and the movable unit pushes the movable unit to communicate the first and second paths. The movable unit moves back to an initial position by pushing the button unit so as to disengage the male connector from the head part.

Preferably, the movable unit includes a first spring to push the elongate hollow part back to the initial position. The valve unit includes a second spring and a valve. The second spring pushes the valve to push the second seal. The second spring also pushes the valve unit back to an initial position of the valve unit. The button unit includes a third spring which is mounted to a protrusion of the button unit so as to push the button unit back to an initial position of the button unit.

Preferably, the movable unit includes a first engaging portion and a second engaging portion, wherein the first and second engaging portions are cone-shaped portions.

Preferably, the button unit includes a frame with an opening. The protrusion extends from one end of the frame. A first positioning face and a second positioning face are respectively formed within the opening of the frame so as to contact the first engaging portion or the second engaging portion. The first positioning face and the second positioning face are located alternatively with each other.

Preferably, the elongate hollow part includes a shoulder formed in the inner periphery thereof.

Preferably, the first seal includes multiple lips which flexibly extend radially from the inner periphery of the first seal.

Preferably, the body includes pressure release bore defined through the wall thereof, and the pressure release bore communicates with the first path.

The first seal of the present invention has a sealing feature when different types of male connectors are connected to the body. The male connectors can be the Industrial male connector, the Aro male connector, the Truflate male connector, the Rectus male connector and the Italian male connector.

The two engaging portions on the elongate hollow part and are located corresponding to the opening of the button unit so that when a male connector is connected to the body, the movable unit pushes the vale away and the positioning faces of the button unit are engaged with the engaging portion to position the elongate hollow part, such that the valve is kept as opened status to communicate the first path with the second path. When the button unit is pushed, the engaging portions are removed from the opening of the button unit, the elongate hollow part moves back to its initial position, and the male connector can be separated from the body, and the valve is closed.

When the male connector is separated from the body and the valve is closed, the pressurized air is released from the pressure release bore of the body to prevent from pushing the male connector to injure the users.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the universal female connector of the present invention;

FIG. 2 is an exploded view of the universal female connector of the present invention;

FIG. 3 is another exploded view of the universal female connector of the present invention;

FIG. 4 is a cross sectional view of the universal female connector of the present invention;

FIG. 5 shows that the Industrial male connector is connected to the universal female connector of the present invention;

FIG. 6 shows that the Aro male connector is connected to the universal female connector of the present invention;

FIG. 7 shows that the Truflate male connector is connected to the universal female connector of the present invention;

FIG. 8 shows that the Rectus male connector is connected to the universal female connector of the present invention;

FIG. 9 shows that the Italian male connector is connected to the universal female connector of the present invention, and

FIG. 10 discloses different conventional male connectors.

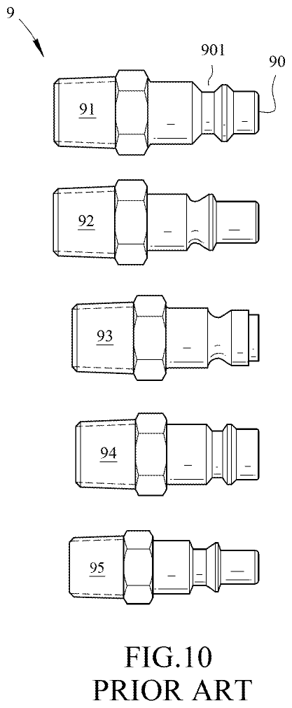

### DETAILED DESCRIPTION OF THE PREFERRED EMBODIMENT

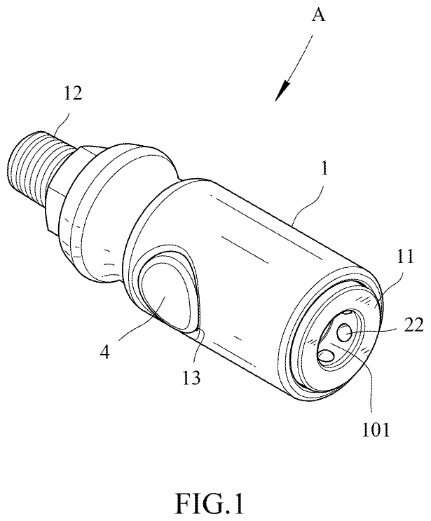

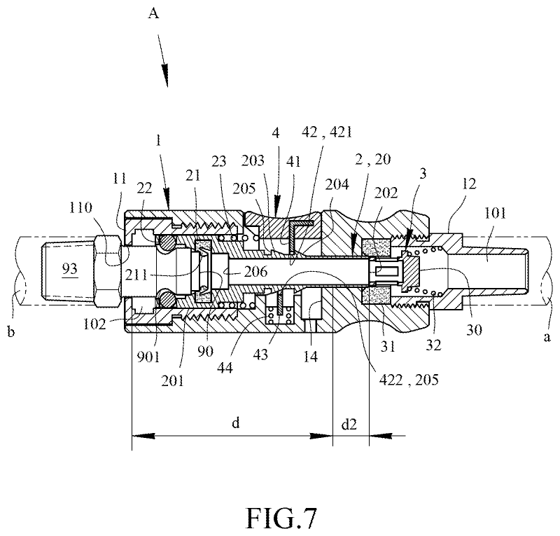

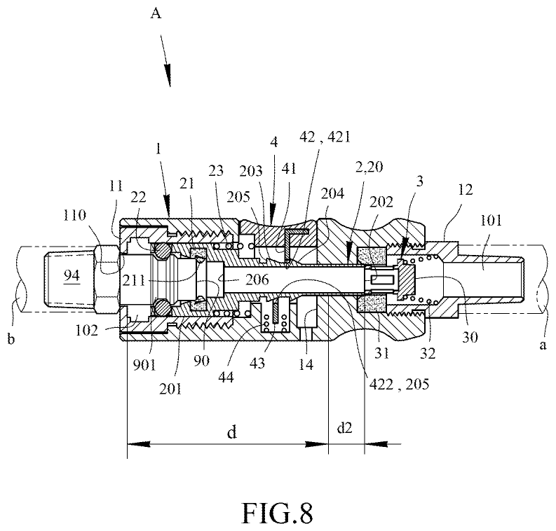

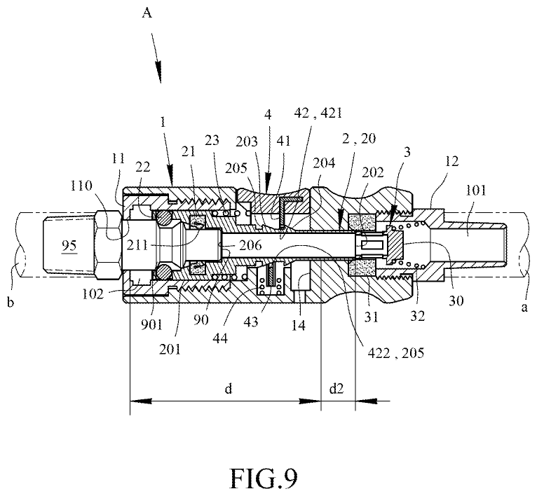

Referring to FIGS. 1, 4 to 9, the universal female connector “A” of the present invention is able to be connected with the Industrial male connector 91, the Aro male connector 92, the Truflate male connector 93, the Rectus male connector 94 and the Italian male connector 95.

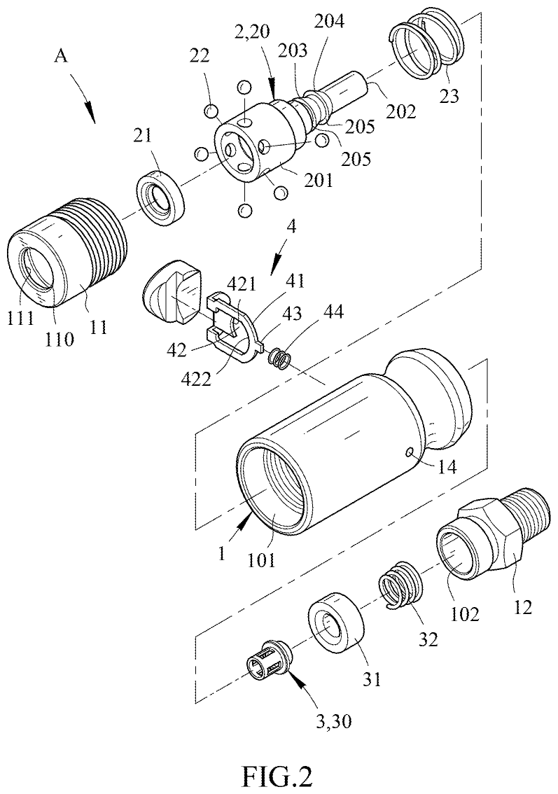

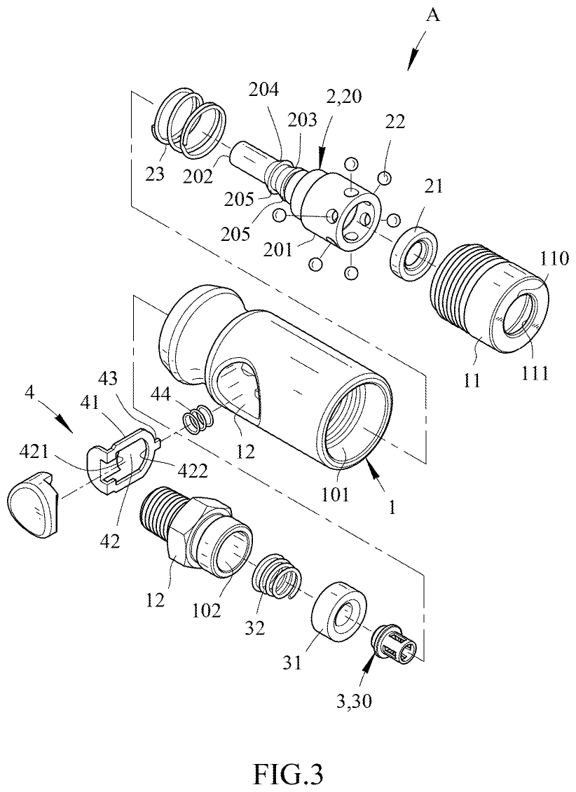

As shown in FIGS. 2 to 4, the universal female connector “A” of the present invention comprises a body 1 having a head part 11 and a tail part 12 respectively connected to two ends of the body 1. A first path 101 is defined axially through the head part 11 and the body 1, and a second path 102 is defined axially through the tail part 12. The first path 101 communicates with, and shares a common axis with the second path 102. The head part 11 includes an annular recess 111 defined in the inner periphery thereof. A hole 14 defined transversely through the wall of the body 1 and communicates with the first path 101.

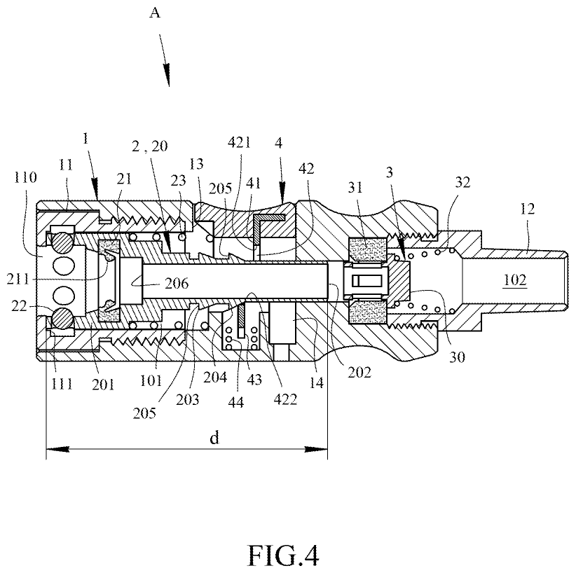

A movable unit 2 is movably located within the first path 11, and the movable unit 2 includes an elongate hollow part 20 which includes a first end 201 and a second end 202. The diameter of the first end 201 of the elongate hollow part 20 is larger than that of the second end 202 of the elongate hollow part 20. A first seal 21 is located in the elongate hollow part 20 and includes multiple lips 211 which flexibly extend radially from the inner periphery of the first seal 21. Multiple beads 22 are movably located in apertures defined through the wall of the first end 201 of the elongate hollow part 20. The beads 22 are to be engaged with the groove 901 of the male connectors 9 mentioned before. Two engaging portions are formed on the outside of the middle portion of the elongate hollow part 20. Specifically, the engaging portions are a first engaging portion 203 and a second engaging portion 204. The first and second engaging portions 203, 204 each are a cone-shaped portion. Further referring to FIG. 4, the movable unit 2 includes a first spring 23 which is biased between the first end 201 of the elongate part 20 and a fixed portion in the first path 101 so as to push the elongate hollow part 20 back to the initial position “d”.

A valve unit 3 is located in the second path 102 of the tail part 12 so as to prevent the pressurized air in the second path 102 from entering into the first part 101. The valve unit 3 is also pushed by the second end 202 of the elongate hollow part 20 to open the second path 102. The valve unit 3 includes a valve 30, a second seal 31 and a second spring 32, wherein the second spring 32 provides a force to let the valve 30 to push the second seal 31 so as to close the second path 102. The second spring 32 also pushes the valve unit 3 back to the initial position of the valve unit 3.

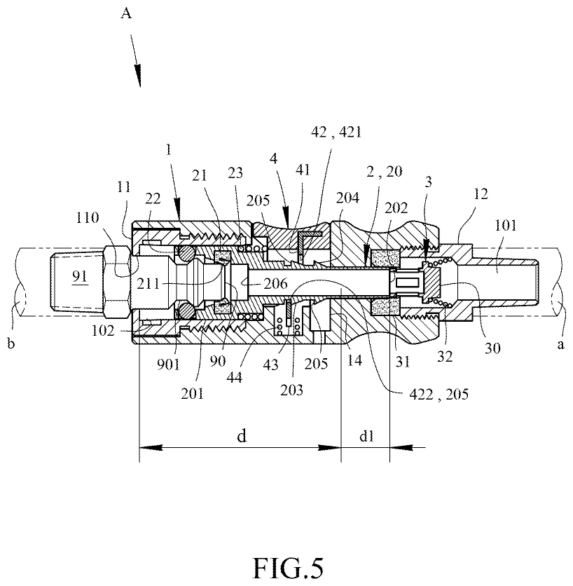

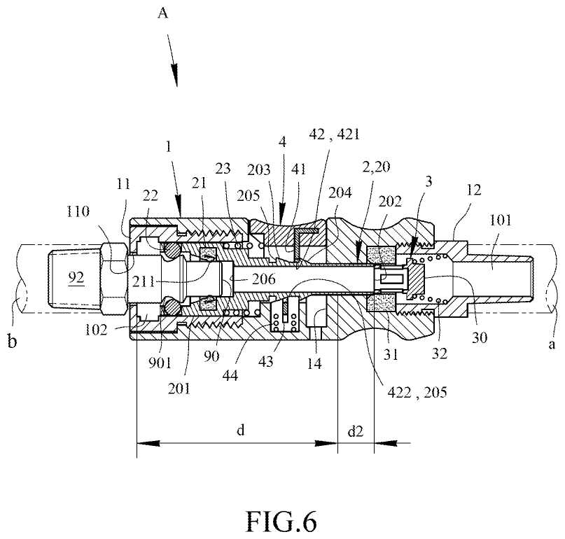

A button unit 4 is movably inserted into the hole 13 of the body 1 to position the elongate hollow part 20. The button unit 4 includes a frame 41 with an opening 42, and a protrusion 43 which extends from one end of the frame 41. The elongate hollow part 20 extends through the opening 42. The third spring 44 is mounted to the protrusion 43 of the button unit 4 so as to push the button unit 4 back to the initial position of the button unit 4. A first positioning face 421 and a second positioning face 422 are respectively formed within the opening 42 of the frame 41. The first positioning face 421 and the second positioning face 422 are located alternatively with each other. The first positioning face 421 and the second positioning face 422 contact the first engaging portion 203 or the second engaging portion 204 to position the elongate hollow part 20 and the valve unit 3 at two positions as shown in FIGS. 5 and 6.

As shown in FIG. 4 which shows the initial status of the universal female connector “A” of the present invention. The first end 201 is biased by the first spring 23 so that the first end 201 contacts the entrance 110 of the head part 11, and the beads 22 of the elongate hollow part 20 are freely movable in the annular groove 111. The valve unit 3 is pushed by the second spring 32 to close the communication between the first and second paths 101, 102, so that the pressurized air in the second path 102 cannot flow into the first path 101. The frame 41 of the button unit 4 is biased by the third spring 44, the second positioning face 422 contacts the outside the second end 202 of the elongate hollow part 20.

FIG. 5 shows that the universal female connector “A” of the present invention is to be connected with the Industrial male connector 91, and a first hose “a” is connected to the universal female connector “A” The Industrial male connector 91 is connected with a second hose “b”. When the front end 90 of the Industrial male connector 91 is moved and touches the lips 211 of the first seal 21, the elongate hollow part 20 with the beads 22 are moved back, and the beads 22 are restricted by the inside of the head part 11 so that the beads 22 are engaged with the groove 901 of the Industrial male connector 91.

When the Industrial male connector 91 continuously moved, the elongate hollow part 20 with the beads 22 compress the first spring 23 to store energy. The cone-shaped first engaging portion 203 pushes the first and second positioning faces 421, 422 so that the frame 41 is moved and compresses the third spring 44 to store energy, until the vertical face 205 of the first engaging portion 203 is stopped at the second positioning face 422 of the frame 41 to position the elongate hollow part 20 at the first position “d1”. The beads 22 position the Industrial male connector 91, so that the first and second hoses “a”, “b” communicate with each other.

When the elongate hollow part 20 is positioned by the opening 42 of the frame 41, the second end 202 of the elongate part 20 moves the valve 30 of the valve unit 30 to form a gap between the valve 30 and the second seal 31, such that the pressurized air is allowed to flow from the first path 101 to the second path 102 via the gap. The pressurized fluid in the second path 102 flows to the first path 101 and the second hose “b”. The valve 30 compresses the second spring 32 to store energy.

When the users want to close the communication between the first and second hoses “a” and “b”, the button unit 4 is pushed to move the frame 41 so that the second positioning face 422 is separated from the vertical face 205 of the first engaging portion 203, and the first spring 23 pushes the elongate hollow part 20 back to the initial position “d”, and the Industrial male connector 91 is separated from the universal female connector “A”. The valve 30 of the valve unit 3 moves to its initial position by the second spring 32 so that there is no gap formed between the valve 30 and the second seal 31 so that the first path 101 does not communicate with the second path 102. The button unit 4 moves back to its initial position by the third spring 44.

As shown in FIG. 6, when the universal female connector “A” of the present invention is to be connected with the Aro male connector 92, the front end 90 of the Aro male connector 92 is moved and touches the lips 211 of the first seal 21, front end 90 is engaged with the shoulder 206, and the beads 22 are restricted by the inside of the head part 11 so that the beads 22 are engaged with the groove 901 of the Aro male connector 92. When the Aro male connector 92 is continuously moved, the elongate hollow part 20 with the beads 22 compress the first spring 23 to store energy. The vertical face 205 of the second engaging portion 204 is stopped at the first positioning face 421 of the frame 41 to position the elongate hollow part 20 at the second position “d2”. The valve 30 is then opened and the beads 22 position the Aro male connector 92, so that the first and second hoses “a”, “b” communicate with each other.

When the users want to close the communication between the first and second hoses “a” and “b”, the button unit 4 is pushed to move the frame 41 so that the first positioning face 421 is separated from the vertical face 205 of the second engaging portion 204, and the first spring 23 pushes the elongate hollow part 20 back to the initial position “d”, and the Aro male connector 92 is separated from the universal female connector “A”. The valve is closed and no gap is formed so that the first path 101 does not communicate with the second path 102.

FIGS. 6, 7, 8 and 9 show the universal female connector “A” is connected with the Truflate male connector 93, the Rectus male connector 94, the Italian male connector 95, the steps are the same as the description regarding the connection between the Aro male connector 92 with the universal female connector 92. However, the front end 90 of the Truflate male connector 93 and the Rectus male connector 94 is not engaged with the shoulder 206.

As shown in FIG. 5, the valve 30 can be opened, when the Aro male connector 92, the Truflate male connector 93, the Rectus male connector 94, and the Italian male connector 95 are positioned at the second position “d2” by the button unit 4. The vertical face 205 of the second engaging portion 204 is stopped at the first positioning face 421 of the frame 41 so as to position the elongate hollow part 20 at the second position “d2”. Differently, for the Industrial male connector 91, the valve 30 can be opened when the vertical face 205 of the first engaging portion 203 is stopped at the second positioning face 422 of the frame 41 so as to position the elongate hollow part 20 at the first position “d1”.

While we have shown and described the embodiment in accordance with the present invention, it should be clear to those skilled in the art that further embodiments may be made without departing from the scope of the present invention.

What is claimed is:

1. A universal female connector comprising:
a body having a head part and a tail part respectively connected to two ends of the body, a first path defined axially through the head part and the body, a second path defined axially through the tail part, the first path communicating with the second path, the head part including an annular recess defined in an inner periphery thereof, a hole defined transversely through a wall of the body and communicating with the first path;
a movable unit movably located within the first path, the movable unit being an elongate hollow part and including a first end and a second end, a diameter of the first end of the elongate hollow part being larger than that of the second end of the elongate hollow part, a first seal located in the elongate hollow part, multiple beads movably located in apertures defined through a wall of the first end of the elongate hollow part, multiple engaging portions formed on an outside of a middle portion of the elongate hollow part;
a valve unit located in the second path of the tail part and including a second seal, the valve unit adapted to prevent air in the second path from entering into the first part, and
a button unit movably inserted into the hole of the body to position the elongate hollow part.

2. The universal female connector as claimed in claim 1, wherein the first seal is adapted to be pushed by a male connector connected to the head part, the elongate hollow part is moved to be engaged with the button unit and the movable unit pushes the movable unit to communicate the first and second paths, the movable unit moves back to an initial position by pushing the button unit so as to disengage the male connector from the head part.

3. The universal female connector as claimed in claim 2, wherein the movable unit includes a first spring to push the elongate hollow part back to the initial position, the valve unit includes a valve and a second spring, the second spring pushes the valve to push the second seal, the second spring pushes the valve unit back to an initial position of the valve unit, the button unit includes a third spring which is mounted to a protrusion of the button unit so as to push the button unit back to an initial position of the button unit.

4. The universal female connector as claimed in claim 3, wherein the movable unit includes a first engaging portion and a second engaging portion, the first and second engaging portions are cone-shaped portions.

5. The universal female connector as claimed in claim 4, wherein the button unit includes a frame with an opening, the protrusion extends from one end of the frame, a first positioning face and a second positioning face are respectively formed within the opening of the frame so as to contact the first engaging portion or the second engaging portion, the first positioning face and the second positioning face are located alternatively with each other.

6. The universal female connector as claimed in claim 1, wherein the elongate hollow part includes a shoulder formed in an inner periphery thereof.

7. The universal female connector as claimed in claim 1, wherein the first seal includes multiple lips which flexibly extend radially from an inner periphery of the first seal.

8. The universal female connector as claimed in claim 1, wherein the body includes pressure release bore defined through the wall thereof, the pressure release bore communicates with the first path.

9. The universal female connector as claimed in claim 1, wherein a body of the universal female connector is adapted to be connected with an Industrial male connector, an Aro male connector, a Truflate male connector, a Rectus male connector or an Italian male connector.
